(19) United States
(12) Patent Application Publication
(10) Pub. No.: US 2009/0295324 A1
(43) Pub. Date: Dec. 3, 2009

(54) Device and method for controlling manipulator

(75) Inventors: Young Bo Shim, Seoul (KR); Yeon Taek Oh, Yongin-si (KR); Sukjune Yoon, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 12/382,245

(22) Filed: Mar. 11, 2009

(30) Foreign Application Priority Data
May 30, 2008 (KR) 10-2008-0050848

(51) Int. Cl. G05B 19/404

(52) U.S. Cl. 318/632

(57) ABSTRACT

Disclosed herein are a device and method of controlling a manipulator. The device includes a device to control a manipulator, including a sensing unit to sense a joint position and joint torque of the manipulator a disturbance estimator to estimate disturbance torque using a state space equation with respect to the manipulator having the sensed joint position and joint torque as input; and a controller to control the manipulator based on the estimated disturbance torque.

### CROSS-REFERENCE TO RELATED APPLICATIONS

This application claims the benefit of Korean Patent Application No. 2008-0050848, filed May 30, 2008 in the Korean Intellectual Property Office, the disclosure of which is incorporated herein by reference.

### BACKGROUND

1. Field

The general inventive concept relates to a device and method of controlling a manipulator, and, more particularly, to a device and method of controlling a manipulator that are capable of estimating disturbance torque applied to the manipulator to detect the collision between the manipulator and people, and controlling the flexibility of the manipulator such that people are not hurt when the manipulator collides with the people.

2. Description of the Related Art

General industrial robots are being widely used in production lines to perform accurate operations without manipulation or supervision of people. For example, robots used in an automobile industry perform various jobs, such as transportation and welding of automobile frames.

Unlike the general industrial robots, intelligent service robots (hereinafter referred to as “robots”) perform operations in a space in which people reside. Consequently, there is a possibility that the robots collide with people, and, as a result, the people are hurt. For this reason, it is critical to maintain safety of the people. It is particularly critical for manipulators, which have the greatest possibility of colliding with people. The manipulators are mechanical apparatuses formed in the shape of hands and arms of people to provide hand and arm movements. Most manipulators which are presently being used are constructed by interconnecting several links. Each connection between the respective links is called a joint. For the manipulators, the dynamic characteristics are decided based on geometric relationships between the links and the joints.

As a general technical solution therefore, a methodology that improves software intelligence of the manipulators to previously recognize obstacles around the manipulators and predict a possibility of collision therethrough to remove a danger is ideal. However, calculation speed and other algorithms/intelligence implementation levels do not secure absolute safety. Consequently, it is indispensable to provide a safety measure at the time of collision in developing a manipulator.

When a manipulator collides with people, it is necessary to provide the manipulator with flexibility such that the people are not hurt. Such a technical solution is called robot compliance. Methods of providing the manipulator with the robot compliance include a passive method of providing the manipulator with flexibility through a mechanical mechanism using elements such as springs or dampers and an active method of providing the manipulator with appropriate flexibility against external forces or impacts by detecting a feedback signal from a sensor mounted at the manipulator through a controller.

When the manipulator collides with people, such collision must be accurately detected. Japanese Patent Application Publication Nos. 6-131050 and No. 11-254380 disclose methods of estimating disturbance torque applied to a robot arm by a disturbance estimator and, when the disturbance torque exceeds a predetermined value, determining that the robot arm has collided with people. These methods detect the collision between the robot arm and the people without using a collision sensor, e.g., a force sensor.

In the relevant technology, the disturbance estimator acquires disturbance torque by a state space equation based on a dynamic model of the manipulator expressed below.

M\ddot{q}+C\dot{q}+g=τ−d Equation [1]

Where, M is an inertia matrix of the manipulator, C is a Corioli's and centrifugal matrix, g is a gravity vector, T is driving torque applied to each joint, d is disturbance torque of each joint generated by an external force of action, \ddot{q} is joint acceleration, and \dot{q} is joint velocity.

As can be seen from Equation [1], the joint acceleration must be known in order to estimate the disturbance torque in the conventional art. Consequently, it is necessary to measure and quadratically differentiate the position of each joint in order to know the joint acceleration. Alternatively, it is necessary to additionally install an acceleration sensor at each joint of the manipulator.

However, when the quadratic differentiation is made on the detected position value of each joint to acquire the joint acceleration, even noise included in the detected position value of each joint is also amplified, with the result that it is difficult to accurately acquire the joint acceleration. Also, when the acceleration sensor is installed at each joint of the manipulator, the acceleration sensor acts as an element restricting the movement of the manipulator, and it may be difficult to accurately acquire the joint acceleration due to sense noise. Furthermore, the manufacturing costs increase due to the addition of parts, and it is difficult to maintain the manipulator.

### SUMMARY

Accordingly, it is an aspect of the present general inventive concept to provide a device and method of controlling a manipulator that is capable of accurately estimating disturbance torque applied to the manipulator without using joint acceleration of the manipulator.

Additional aspects and/or advantages of the present general inventive concept will be set forth in part in the description which follows and, in part, will be apparent from the description, or may be learned by practice of the general inventive concept.

The foregoing and/or other aspects and utilities of the present general inventive concept may be achieved by providing a device to control a manipulator, including a sensing unit to sense a joint position and joint torque of the manipulator, a disturbance estimator to estimate disturbance torque using a state space equation with respect to the manipulator having the sensed joint position and joint torque as input, and a controller to control the manipulator based on the estimated disturbance torque.

The foregoing and/or other aspects and utilities of the present general inventive concept may be achieved by providing a method of controlling a manipulator, including sensing a joint position and a joint torque of the manipulator and estimating disturbance torque using a state space equation with respect to the manipulator based on the sensed joint position and joint torque.

### BRIEF DESCRIPTION OF THE DRAWINGS

These and/or other aspects and advantages of the present general inventive concept will become apparent and more readily appreciated from the following description of the embodiments, taken in conjunction with the accompanying drawings, of which:

FIG. 1 is a view schematically illustrating the structure of a manipulator according to an embodiment of the present invention;

FIG. 2 is a control block diagram illustrating a device controlling a manipulator according to the embodiment of the present general inventive concept;

FIG. 3 is a view illustrating a disturbance estimator of FIG. 2; and

FIG. 4 is a view illustrating the change in stiffness of the manipulator when the manipulator according to the embodiment of the present general inventive concept collides with an object.

### DETAILED DESCRIPTION OF EMBODIMENT

Reference will now be made in detail to the embodiment of the present general inventive concept, an example of which is illustrated in the accompanying drawings, wherein like reference numerals refer to like elements throughout. The embodiment is described below to explain the present general inventive concept by referring to the figures.

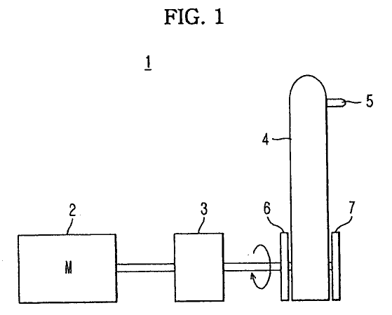

First, a manipulator to which the embodiment of the present invention is applied will be briefly described. FIG. 1 is a view schematically illustrating a 1 degree of freedom manipulator 1 constructed in a structure in which an actuator and a link are coupled to each other via a speed reducer.

Referring to FIG. 1, the manipulator 1 includes an actuator 2, a speed reducer 3, a link 4, an end effector 5, a torque sensor 6, and a position sensor 7. The actuator 2 is implemented by a servo motor. The actuator 2 is connected to the link 4 via the speed reducer 3. The actuator 2 rotates to move the link 4. The end effector 5 is provided at the end of the link 2 to directly perform an operation. The torque sensor 6 and the position sensor 7 constitute a sensing unit. The torque sensor 6 senses joint torque of the manipulator 1, and the position sensor 7 senses a joint position of the manipulator 1. For reference, when a high-efficiency speed reducer is adopted, a current sensor to sense drive current of the actuator may be used instead of the torque sensor. In this case, the joint torque of the manipulator is estimated from the drive current of the actuator.

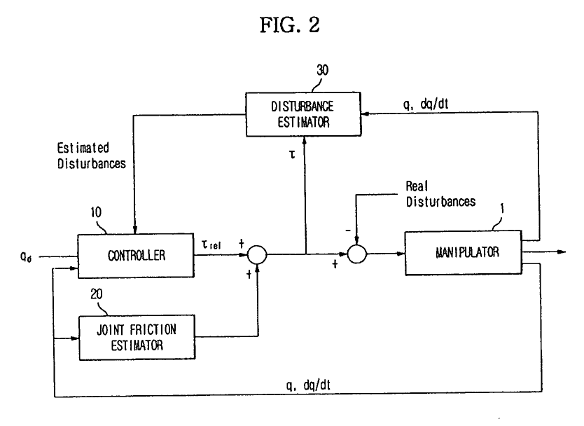

FIG. 2 is a control block diagram schematically illustrating a device controlling a manipulator according to an embodiment of the present invention. As illustrated in FIG. 2, the manipulator controlling device includes a disturbance estimator 30 to estimate disturbance torque using a state space equation with respect to the manipulator having a joint position and joint torque, sensed by the sensing unit that senses the joint position and joint torque of the manipulator, as input and a controller 10 to control the manipulator based on the disturbance torque estimated by the disturbance estimator 30.

First, a target position value qd, and a joint position q and joint velocity dq/dt of the manipulator are inputted to the controller, operating for each sample within a total control cycle. The controller outputs reference joint torque τref to control the manipulator to a target position based on the inputted information. The manipulator is operated by the reference joint torque τref transmitted from the controller 10 to the manipulator. Also, the reference joint torque τref transmitted from the controller 10 to the manipulator is inputted to the disturbance estimator 30. At this time, when joint friction of the manipulator is not compensated for, joint torque τ inputted to the disturbance estimator 30 is the reference joint torque τref. However, when joint friction estimated by a joint friction estimator 20 exists to compensate for the joint friction to improve system efficiency, joint torque τ inputted to the disturbance estimator 30 is the sum of the reference joint torque τref and the estimated joint friction value.

Meanwhile, when the manipulator collides with an object during the operation of the manipulator, the output of the manipulator is changed by real disturbances due to the collision. The output q and dq/dt of the manipulator is fed back to the input of the controller 10 and the joint friction estimator 20. Also, the output q and dq/dt of the manipulator is fed back to the input of the disturbance estimator 30.

The disturbance estimator 30 estimates disturbance torque using a state space equation based on a dynamic model with respect to the manipulator having the joint position q, the joint velocity dq/dt, and joint torque τ of the manipulator as input. Consequently, it is possible for the disturbance estimator 30 to estimate disturbance torque without using joint acceleration.

Meanwhile, disturbances estimated by the disturbance estimator 30 (estimated disturbances) are inputted to the controller 10. When the estimated disturbances exceed a predetermined value, the controller 10 determines that the manipulator has collided with the object. When it is determined that the manipulator has collided with the object, the controller 10 changes the stiffness of the manipulator, such that the manipulator is structurally flexible, to minimize physical impact. A technology of changing the stiffness of the manipulator is disclosed in Korean Patent Application Publication No. 2008-0014343. This technology is characterized by a joint mechanism that mechanically changes the stiffness of the manipulator such that the manipulator maintains high stiffness in a normal operation state and low stiffness when impact having more than a predetermined magnitude is applied to the manipulator.

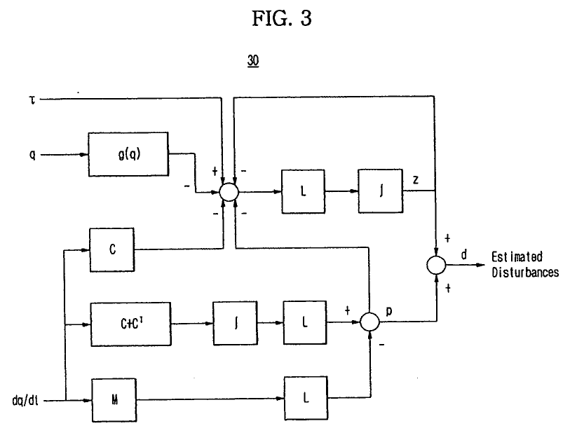

Hereinafter, a method of estimating disturbance torque by the disturbance estimator 30 will be described with reference to FIG. 3.

As previously described, a state space equation based on a dynamic model with respect to the manipulator may be represented by Equation [1].

When Equation [1] is arranged with respect to disturbance torque, Equation [2] is obtained.

d=τ+(−M\ddot{q}−C\dot{q}−g) Equation [2]

Where, M is an inertia matrix of the manipulator, C is a Corioli's and centrifugal matrix, g is a gravity vector, τ is driving torque applied to each joint, d is disturbance torque of each joint generated by an external force of action, \ddot{q} is joint acceleration, and \dot{q} is joint velocity.

The recognition of the disturbance torque results in the acquisition of the value of the following d.

However, there are many factors affecting the reliability of data, such as noise of a signal and uncertainty of a model, in directly acquiring the disturbance torque from a sensor. Consequently, an estimated value represented by Equation [3] is used.

$$\dot{\hat{d}} = - L \hat{d} + L ( τ - M \ddot{q} - C \dot{q} - g ) \qquad Equation [ 3 ]$$

Where, L is a positive definite matrix, which is a gain matrix of the estimator. Also, the disturbance torque is generated in a relatively low frequency region. Consequently, Equation [4] is assumed.

\dot{d}=0 Equation [4]

An auxiliary state variable represented by Equation [5] is defined to easily solve a problem in designing the disturbance estimator 30 and not to use an acceleration sensor for each joint. Generally, the joint acceleration is acquired by differentiating a joint angle (joint position) twice. In this case, a signal noise is amplified.

[symbol]

=\hat{d}−p Equation [5]

When a state transition equation with respect to the state variables z and p is derived, Equation [6] may be obtained.

$$\begin{matrix}\begin{matrix}= \dot{\hat{d}} - \dot{p} \\ = - L \dot{d} + L ( τ - M \dot{q} - C \dot{q} - g ) - \dot{p} \\ = - L - Lp + L ( τ - M \ddot{q} - C \dot{q} - g ) - \dot{p} \\ = - L + L ( τ - M \ddot{q} - C \dot{q} - g - p ) - \dot{p}\end{matrix} & Equation [ 6 ]\end{matrix}$$

At this time, dynamics of p are defined as represented by Equation [7] in order to remove the influence of the joint acceleration sensor.

\dot{p}=−LM\ddot{q} Equation [7]

Therefore, when Equation [6] is represented again with it, Equation [8] is obtained.

[symbol]

=−L [symbol] +L(τ−C\dot{q}−g−p) Equation [8]

Dynamic equation [7] of p may be redefined as Equation [9] and Equation [10] by a relation equation between matrices constituting Manipulator model equation [1].

$$\begin{matrix}\dot{M} = C + {C}^{T} & Equation [ 9 ] \\ \begin{matrix}\dot{p} = - LM \ddot{q} \\ = - L ⌊ M \dot{q} - \int \dot{M} \dot{q} d t ⌋ \\ = - LM \dot{q} + L \int ( C + {C}^{T} ) \dot{q} d t\end{matrix} & Equation [ 10 ]\end{matrix}$$

Where, C^{T} is a transpose matrix of C.

Equation [10] may be obtained by partially integrating Equation [7].

When a governing equation of the disturbance estimator 30 is represented by arranging the above processes, Equations [11] to [13] are obtained.

$$\begin{matrix}\hat{d} = + p & Equation [ 11 ] \\ + L ( τ - C \dot{q} - g - p ) & Equation [ 12 ] \\ \dot{p} = - LM \dot{q} + L \int ( C + {C}^{T} ) \dot{q} d t & Equation [ 13 ]\end{matrix}$$

FIG. 3 sequentially illustrates the above processes.

At this time, the error of the disturbance estimator 30 converging to 0 may be proven using a Lyapunov stability theory as follows.

That is, the error term of the disturbance estimator is defined by the following equations.

e=d−\hat{d} Equation [14]

ė=\dot{d}−{dot over (\hat{d} Equation [15]

When a Lyapunov function is defined as represented by Equation [16]

$$V ( e , \dot{e} ) = \frac{1}{2} {e}^{T} Ke > 0 \\ ( for K > 0 ) \qquad Equation [ 16 ]$$

The differentiation thereof is defined as represented by Equation [17], and it can be seen that it is always negative semidefinite.

\dot{V}(e,ė)=ė^{T}Ke=−e^{T}L^{T}Ke<0(∵L^{T}K<0) Equation [17]

Equation [17] is derived by error dynamics of Equation [18] below.

$$\begin{matrix}\begin{matrix}\dot{e} = \dot{d} - \dot{\hat{d}} \\ = - - \dot{p} \\ = L - L ( τ - C \dot{q} - g - p ) + LM \ddot{q} \\ = L ( - d + p ) \\ = L ( \hat{d} - d ) \\ = - L ( d - \hat{d} ) \\ = - Le\end{matrix} & Equation [ 18 ]\end{matrix}$$

Therefore, the estimated error of the disturbance estimator always converges to 0, and it can be mathematically proven that the disturbances estimated by the disturbance estimator are reliable.

In this embodiment, the dynamic effect is compensated for through feedforward based on a model, not the conventional simple position control. Consequently, it is possible to provide the same control efficiency at any position of the manipulator. Subsequently, when it is determined from the result estimated by the disturbance estimator that the manipulator has collided with an object, it is necessary to take an appropriate measure to avoid the collision or absorb impact. In this embodiment, a control gain is changed according to the magnitude of the recognized impact to change the stiffness of the manipulator. When the impact force exceeds a specific critical value, a proportional control or differentiation control gain is lowered to reduce the system stiffness and attenuation, thereby minimizing a counteraction applied to the object.

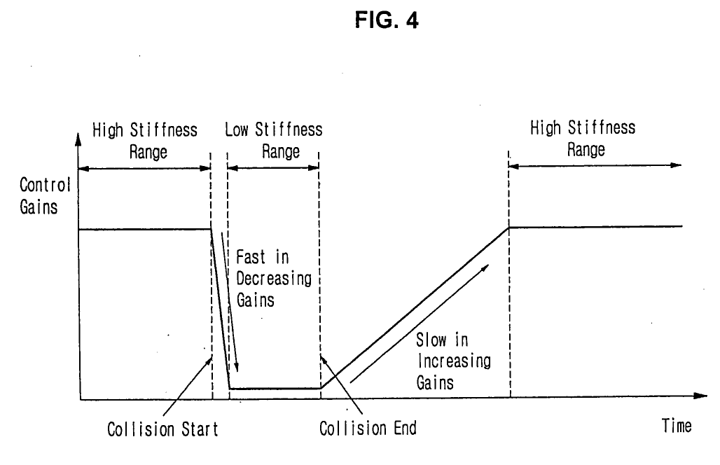

FIG. 4 is a view illustrating the change in stiffness of the manipulator when the manipulator according to the embodiment of the present invention collides with an object. A value of the control gain according to time after the collision may be explained by a graph of FIG. 4. That is, when the manipulator collides with the object, the control gain is sharply lowered to lower the stiffness of the manipulator, and, when the collision between the manipulator and the object is settled, the control gain is slowly raised to raise the stiffness of the manipulator to its original level.

According to the general inventive concept, it is possible to accurately estimate disturbance torque applied to a manipulator without using joint acceleration of the manipulator, and therefore, it is not necessary to quadratically differentiate joint positions or install additional acceleration sensors in order to acquire the joint acceleration. Consequently, the embodiment of the present invention has the effect of more accurately estimating disturbance torque, reducing the manufacturing costs of the manipulator, increasing spatial utilization, and achieving easy and convenient maintenance.

Although an embodiment has been shown and described, it would be appreciated by those skilled in the art that changes may be made in this embodiment without departing from the principles and spirit of the invention, the scope of which is defined in the claims and their equivalents.

What is claimed is:

1. A device to control a manipulator, comprising:
a sensing unit to sense a joint position and joint torque of the manipulator;
a disturbance estimator to estimate disturbance torque using a state space equation with respect to the manipulator having the sensed joint position and joint torque as input; and
a controller to control the manipulator based on the estimated disturbance torque.

2. The device of claim 1, wherein the disturbance estimator estimates the disturbance torque based on a joint torque value, a gravity compensation value, a Corioli's force compensation value, and an inertia compensation value of the manipulator.

3. The device of claim 1, wherein the state space equation includes the following equations.
\hat{d}= [symbol] +p [symbol]
=−L [symbol] +L(τ−C\dot{q}−g−p)
\dot{p}=−LM\dot{q}+L∫(C+C^{T})\dot{q}dt
wherein d is an estimated value of the disturbance torque, Z is a state variable, p is a state variable, L is a positive definite matrix, ζ is a driving torque, C is a Corioli's and centrifugal matrix, q is a joint velocity, g is a gravity vector and M is an inertia.

4. The device of claim 1, wherein the sensing unit includes a position sensor to sense the joint position of the manipulator and a torque sensor to sense the joint torque of the manipulator.

5. The device of claim 1, further comprising a motor and a joint, wherein the sensing unit includes a position sensor to sense the joint position of the manipulator and a current sensor to sense current of the motor that drives the joint of the manipulator, the joint torque being estimated from the sensed current of the motor.

6. The device of claim 1, wherein the manipulator has variable stiffness, and, when the disturbance torque estimated by the disturbance estimator exceeds a predetermined value, the controller changes a stiffness of the manipulator.

7. A method of controlling a manipulator, comprising:
sensing a joint position and a joint torque of the manipulator; and
estimating disturbance torque using a state space equation with respect to the manipulator based on the sensed joint position and joint torque.

8. The method of claim 7, wherein the estimating the disturbance torque includes estimating the disturbance torque using the following state space equations.
\hat{d}= [symbol] +p [symbol]
=−L [symbol] +L(τ−C\dot{q}−g−p)
\dot{p}=−LM\dot{q}+L∫(C+C^{T})\dot{q}dt
wherein d is an estimated value of the disturbance torque, Z is a state variable, p is ______, L is a positive definite matrix, ζ is a driving torque, C is a Corioli's and centrifugal matrix, q is a joint velocity, g is a gravity vector and M is an inertia,

9. The method of claim 7, further comprising:
changing a stiffness of the manipulator based on the estimated disturbance torque.

10. The method of claim 9, wherein the changing the stiffness includes comparing the estimated disturbance torque with a predetermined value, determining that the manipulator has collided with an object when the estimated disturbance torque exceeds the predetermined value, and changing the stiffness of the manipulator based on the result of the determination.
